(19) United States
(12) Patent Application Publication
(10) Pub. No.: US 2014/0284433 A1
(43) Pub. Date: Sep. 25, 2014

(54) Downspout Extension Ground Support

(71) Applicant: Jeanne M. Gazlay, Tampa, FL (US)

(72) Inventor: Jeanne M. Gazlay, Tampa, FL (US)

(21) Appl. No.: 14/299,719

(22) Filed: Jun. 9, 2014

Related U.S. Application Data
(63) Continuation-in-part of application No. 13/287,708, filed on Nov. 2, 2011, now abandoned.

(51) Int. Cl. F16L 1/024; F16L 3/01

(52) U.S. Cl. CPC F16L 1/0246; F16L 3/01
USPC 248/87

(57) ABSTRACT

A support device for a downspout extension is provided, comprising a molded assembly having a U-shaped upper portion and an elongated ground stake lower portion. The upper portion comprises a first and second upright member forming a substantial U-shape, wherein the distal ends thereof include an inward tab extending therefrom. The tabs and the shape of the upper portion are utilized to secure a section of a downspout extension, while the lower portion is adapted to be pressed into the ground a measured distance such that the downspout extension is supported in an elevated position. Graduation indicia are placed along the lower portion to measure the upper portion height relative to the ground, whereby the user can properly pitch a supported downspout extension using consecutive ground support devices. The device ensures proper and continued drainage pitch through a downspout extension, preventing distortions which may otherwise impede proper drainage.

### CROSS REFERENCE TO RELATED APPLICATION

This application claims the benefit to and is a Continuation in Part of U.S. Non-Provisional Application No. No. 13/287,708 filed on Nov. 2, 2011, entitled “Downspout Extension Ground Support.” The above-identified patent application is herein incorporated by reference in its entirety to provide continuity of disclosure.

### BACKGROUND OF THE INVENTION

### Field of the Invention

The present invention relates to gutter system supports and ground stakes for supporting segments of a gutter system used to communicate rainwater away from a structure. More specifically, the present invention relates to a ground stake used to support a gutter downspout extension along the ground such that the extension is oriented property and supported along its length to allow for the free flow of water therethrough and away from a foundation.

Gutter systems often are attached to buildings to collect and carry away free-flowing precipitation, such as rainwater, from all or a portion of a building. Gutter systems typically include gutters, or gutter assemblies, and downspouts. Gutter assemblies are commonly attached along the edge of a building's roof such that precipitation, including rainwater, flows from the roof and collects into the gutters. The gutters collect the precipitation into downspouts, which channel the water and direct it into a channel or downspout extension leading away from the structure. This allows water runoff to be controlled and channeled to a location away from the building's foundation. Thus, a free-flowing gutter system reduces or prevents the accumulation of precipitation on the building's roof or around the building's foundation.

In instances where downspouts need to be extended away from the structure, a support mechanism for the downspout extension is required to provide stability and ensure proper drainage. Lack of proper support and stability of downspout extensions can lead to damaged downspouts and improper drainage. Most notably, improperly supported extension portions can separate from the rest of the gutter system, causing leakage of rainwater and local pooling, and therefore an inefficient or completely ineffective gutter system.

When a downspout is extended on ground, it needs to be supported and pitched correctly to ensure proper water flow. Without proper support, the weight of the water will pull down on the downspout extension, causing a change in the pitch of the downspout extension, which can impede the flow of water or create pooling in one area of the gutter system. Furthermore, improperly supported extensions can create undue stress on the connecting joints, leading to premature failures and reduced life expectancy for the particularly system.

The present invention pertains to a ground support that can be used to properly grade and support a downspout extension along its length. The device is a molded, unitary assembly comprised of a U-shaped upper portion and a ground stake lower portion. The upper portion includes a first and second member forming a substantial U-shape. The distal ends of each member include an inwardly projecting tab. The tabs, along with the shape of the upper portion, effectively clamp onto the outer periphery of a standard downspout extension at a given point along its length. The lower portion of the device is a tapered ground stake with graduated indicia thereon. The indicia are used when placing the ground stake into the ground, whereby the proper height of successive support assemblies is determinable relatively to one another along the length of the downspout extension. This allows the installer to properly pitch the extension to facilitate the free flow of water away from the structure foundation.

### DESCRIPTION OF THE PRIOR ART

Devices have been disclosed in the prior art that relate to downspout systems and supports therefor. The following is a list of devices deemed most relevant to the present disclosure, which are herein described for the purposes of highlighting and differentiating the unique aspects of the present invention, and further highlighting the drawbacks existing in the prior art.

One such device that exemplifies the art is U.S. Pat. No. 5,372,457 to Rante, which discloses a device for supporting drainage channels adapted to be embedded into concrete and lie flush with the concrete surface. The device includes a U-shaped bracket, an elongated rod, and a flat plate disposed on the elongated rod for stabilizing the rod after the rod is penetrated through earth. The bracket conforms to the rectangular shape of the drainage channel segment and extends along the sides thereof. The arms of the bracket terminate below the upper surface of the channel such that the channel upper surface is above the Rante device after installation. The elongated rod includes a triangular tip that is pressed into the ground, whereafter the arms of the bracket are positioned against the channel sides and a threadable bolt is used to secure the arms to the sides of the channel.

The Rante device is directed to an assembly that supports drainage channels adapted to be submerged below a layer of earth or concrete, whereby the Rante device is similarly designed to be buried. By contrast, the present invention contemplates an above-ground assembly that is design to support downspout extensions and facilitate visual grading of the extension over an elongated run. The present invention includes a pair of members having an inward tab, whereby the downspout is substantially surrounded by the upstanding members of the device and the tabs are positioned over the extension upper surface to lock the extension within the U-shaped assembly. The upstanding members of the present invention therefore extend above the upper surface of the downspout extension at each attachment point, while the graduated indicia on the lower portion of the device facilitates properly grading and pitching the extension between adjacent support devices.

Finally, the present invention is adapted to be comprised of a unitary, molded part that has no moving parts. The inward tabs of the assembly are used to lock the downspout assembly into place, as opposed to removable fasteners as contemplated by Rante. The present invention therefore is more efficient, includes fewer moving and separable parts, and is directed to a separate use than that of Rante. The device is adapted to for above ground use supporting a downspout extension, whereby one or more devices are pressed into the ground a desired depth, relative to the adjacent support devices and the desired pitch of the downspout extension.

U.S. Patent Publication No. 2005/0160681 to Boelling discloses a retaining clip to locate and secure a downspout extension. The Boelling device comprises an elongated rod formed into a rounded coil, whereby the ends of the rod provide a first and second leg extending away from the coil. The coil includes an opening suitable to position the cross section of a downspout extension, while the legs are pressed into the ground to stabilize the assembly. The Boelling device is a simple construction of a single length of rod, wherein the rod wraps around a downspout extension. The device, however, must be installed by first positioning the downspout extension through the closed coil. The present invention contemplates an open upper such that the support device can be positioned prior to the extension, and the relative height of each support can be determined prior to snapping the extension into the support device and between the inward tabs. The present invention further contemplates depth measurement indicia to accurately gauge the height of successive support devices deployed in a row.

U.S. Pat. No. 603,924 to Sauer discloses a pipe hanging having an upper, U-shaped clamping section and a spike extending therefrom. The Sauer device is a clamp or shackle suitable for holding tubes, wherein two clamping-sections are adapted to enclose a tube while the spike is designed to be driven into a support. The U-shaped clamping section supports a mechanical clamp that ensures that tubing placed within the clamping section is not disturbed or removed, wherein a portion of the clamp extends over the tube to enclose it within the clamping section. While this construction is similar, it fails to contemplate the simplicity of the present invention. The present invention is a molded, unitary part forming a U-shaped assembly with a ground stake lower section. The upper section includes upstanding arms and inwardly directed tabs that are used to clamp a rectangular section of downspout therein, while the ground spike is inserted into the ground a measured distance. The purpose and the construction of the present invention differ from that of the Sauer device.

Similar in structure to the Sauer device is U.S. Pat. No. 5,211,364 to James, which discloses a supporting device for a water board that positions the board above beach sand and in a vertical orientation to prevent the sand from adhering to the board's surface The device comprises a U-shaped upper that accepts the edge of a water board therein and a lower portion that is adapted to be pressed into beach sand. Some embodiments contemplate a central support arm that separates the U-shaped upper into two sections. As with the Sauer device, the James device fails to contemplate the inward tabs of the present invention or the depth indicia marked on the ground spike thereof. The James device is adapted for loosely supporting a water board or surf board in an upright condition and within a cradle above beach sand.

Finally, U.S. Pat. No. 6,206,613 to Elkins discloses a height-adjustable pipe support assembly for laying flexible conduit at a gradually decreasing slant above the ground. The assembly comprises a base pedestal that threadably supports a supporting head. The supporting head comprises a first and second prong, each prong comprising a curved member extending upward from a threaded shaft. The prongs are elastic and the threaded shaft is separable from the base pedestal or threadably connected thereto to adjust the height of the supporting head relative to the base. Similar to the aforementioned devices, the Elkins device fails to contemplate a unitary, molded component having a U-shaped upper portion with inwardly directed tabs for snapping against a downspout extension. The Elkins device is a larger assembly using threaded members and a base that rests on the ground surface. The present invention is adapted to be pressed into the ground using its ground stake lower portion, wherein the height is controlled by the depth of its penetration into the ground.

Overall, the present invention provides a molded part used to support a gutter downspout extension at a defined height above the ground, wherein a plurality of such support devices are deployed in succession and such that the downspout is oriented sufficiently to allow proper drainage away from a building foundation. The device is a molded part that utilizes a U-shaped upper to support the extension. Inward tabs snap the extension within the interior of the upper portion, while the ground stake is placed a measured distance into the ground to properly fix the extension at a location above the ground.

It is submitted that the present invention is substantially divergent in design elements from the prior art, and consequently it is clear that there is a need in the art for an improvement to existing gutter downspout extension support devices. In this regard the instant invention substantially fulfills these needs.

### SUMMARY OF THE INVENTION

In view of the foregoing disadvantages inherent in the known types of support devices now present in the prior art, the present invention provides a new downspout extension support device that can be utilized for providing convenience for the user when supporting a length of downspout above the ground and at the correct pitch for proper drainage of rainwater.

It is therefore an object of the present invention to provide a new and improved gutter downspout extension support device that has all of the advantages of the prior art and none of the disadvantages.

It is another object of the present invention to provide a gutter downspout extension support device to provide a molded part of simple construction and use that can support a downspout extension above the ground and away from the foundation of a home.

Another object of the present invention is to provide a gutter downspout extension support device that includes a ground stake lower portion that includes measurement indicia to measure the penetration depth of the stake to set the correct pitch between successive support devices along an downspout extension.

Yet another object of the present invention is to provide a gutter downspout extension support device that includes upstanding members that surround the sides of a downspout extension and accommodate different shapes and styles thereof, wherein inwardly directed tabs lock the extension between the upstanding members and within the upper portion of the device.

A final object of the present invention is to provide a gutter downspout extension support device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 depicts a perspective view of the downspout extension support device of the present invention.

FIG. 2 shows a close-up view of the upper portion of the downspout extension support device of the present invention.

FIG. 3 shows a frontal close-up view of the upper portion of the downspout extension support device of the present invention supporting an extension therein.

### DETAILED DESCRIPTION OF THE INVENTION

Reference is made herein to the attached drawings. Like reference numerals are used throughout the drawings to depict like or similar elements of the gutter downspout extension support device. For the purposes of presenting a brief and clear description of the present invention, the preferred embodiment will be discussed as used for supporting downspout extensions and properly pitching the same. The figures are intended for representative purposes only and should not be considered to be limiting in any respect.

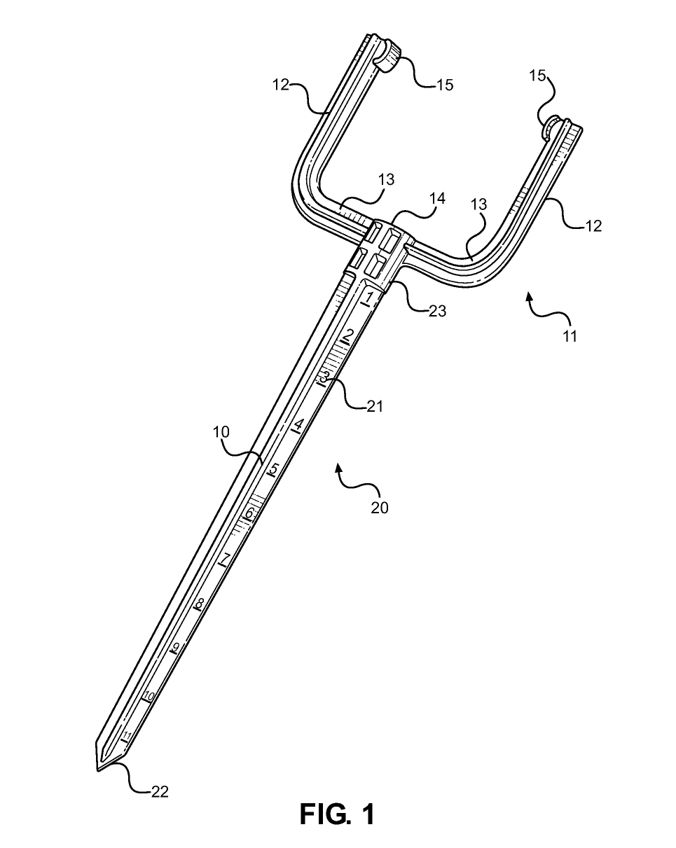

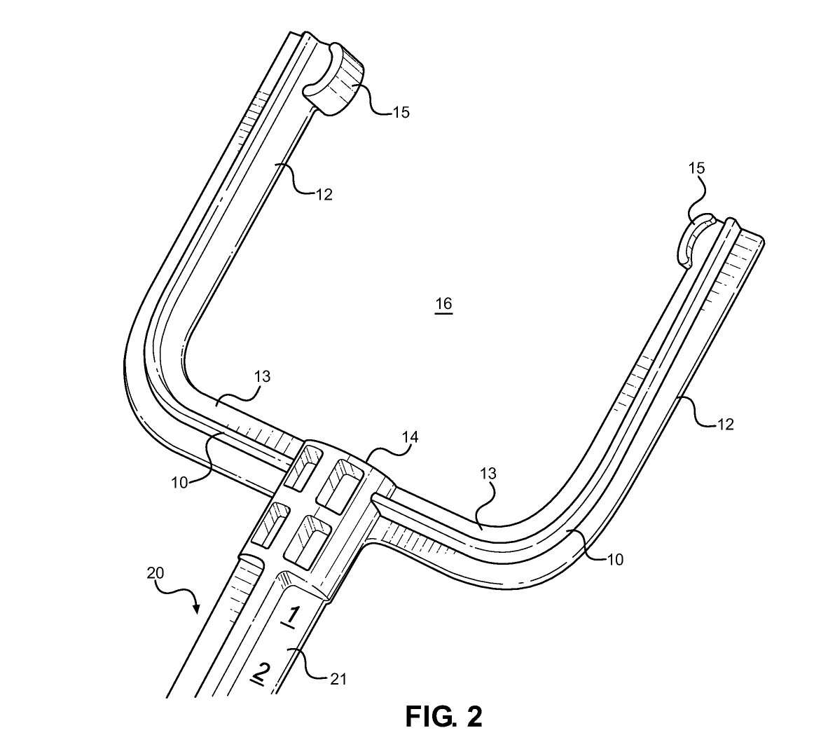

Referring now to FIGS. 1 and 2, there are shown perspective views of the gutter downspout extension support device of the present invention. The device comprises a U-shaped upper portion 11 and a ground stake lower portion 20. The upper portion 11 comprises a first and second upright member 12. The upright members 12 extend upward and are mirror one another. Each member comprises an upper distal end and a lower end. The lower end of each member transitions to a perpendicular portion 13 that connect to a central region 14 at the base of the U-shape. The upper distal ends of the upstanding members further comprise an inwardly directed tab 15, which is adapted to surround the upper edge of a downspout extension placed between the members 12 and secure the same therein. The perpendicular portions 13 of the upper portion 11 and the central region form a horizontal shelf upon which a downspout extension can rest within the U-shaped upper.

Extending downward from the upper portion is an elongated ground stake lower portion 20. The lower portion 20 is adapted to be pressed into the ground a measured distance such that the downspout extension is supported in an elevated position. The lower portion 20 comprises an upper end 23 connected to the upper portion 11 and a lower end 22 adapted to be pressed into the ground. Along the length of the lower portion 20 are graduation indicia 21 thereon. Graduation indicia 21 are placed along the lower portion 20 to measure the elevation of the upper portion 11 relative to the ground, whereby the user can properly pitch a supported downspout extension between successive ground support devices.

The downspout support device of the present invention may be made from a variety of materials that can be molded, machined or formed. The preferred embodiment of the present invention is UV resistant, high impact ABS plastic material that is molded into the shape as depicted in FIGS. 1 through 3. The best mode contemplated for its construction is ABS plastic injected molded into a unitary structure that is generally U-shaped and continuous between the upper portion 11 and lower portion 20. The lower end 22 of the ground stake preferably tapers to a point to improve penetration, while an upstanding vein 10 is molded into the upstanding members 12 and the ground stake to improve stability and strength of the device while deployed. The vein 10 is a molded feature that improves strength and reduces yielding of the material, and is disposed along the upper and lower portions of the device. The vein extends outward from the front and rear surfaces of the device and extends upwards along the U-shaped upper and downwards along the ground stake lower portion.

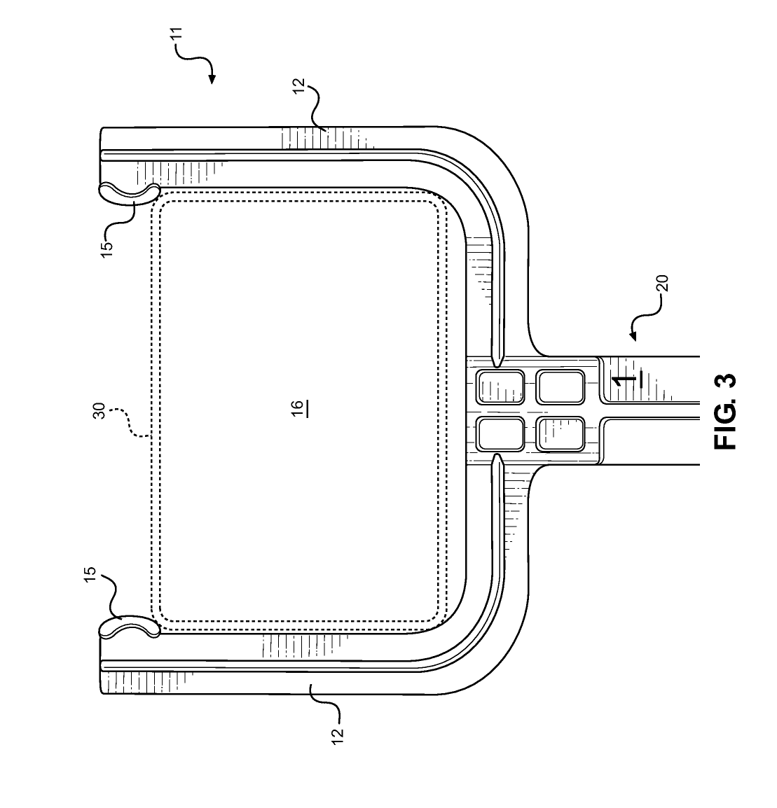

Referring now to FIG. 3, there is shown an illustration of the present invention in a working state, wherein a frontal view of the upper portion 11 is shown with an example downspout extension 30 secured within its U-shape. When supporting a downspout extension 30, the inward tabs 15 of the upstanding members 12 lock the extension 30 into the interior 16 of the upper portion 11 and prevent easy separation. Therefore the extension 30 is maintained in a stable configuration by the present invention, while the ground stake lower portion 20 positions the extension at a desired elevation above the ground and relative to adjacent support devices.

Although the dimensions of the downspout extension support device of the present invention can be customized to secure in place any size downspout extension or draining device, FIG. 3 depicts the configuration of the upper portion 11 that will accommodate a standard 3×4 inch downspout extension inserted with a 4 inch side down. Overall, it is contemplated that the width, height, shape and inward extent of the inward tabs will be determined by the drainage mechanism chosen.

During installation of a downspout extension, the present invention is used to support and maintain the position of the extension at defined locations moving outward from a foundation. The measurement indicia on the ground stake are used to set the correct pitch between successive support devices, whereby the extension is properly pitched downward and away from the home once secured by all deployed support devices. This prevents pooling and even backflow of rainwater running through the downspout extension. The support devices furthermore prevent connected extension pieces from separating or sagging, thereby ensuring continued drainage by preventing distortions that may otherwise impede proper drainage.

The graduated measurement indicia on the lower portion comprise a series of consecutive numbers extending from the upper end of the lower portion to the lower end thereof. In this way, the installer can measure the penetration depth of the lower end and control the relative heights of consecutive support devices along the length of an extension. This is critical for setting the appropriate height and pitch of the extension.

The ground stake lower portion is pushed or driven into the ground to provide support and stability for the downspout extension held by the upper portion of the device. The downspout extension sits on top of the horizontal portion between the pair of upstanding members. The upstanding members on each side of the U-shaped upper hold the downspout extension in place and prevent side to side movement. The inwardly directed locking tabs are protrusions at the upper distal end of each member that prevent the downspout extension from lifting up once installed therein.

In instances where downspouts need to be extended from a structure, the present invention provides support and stability to maintain the correct pitch for drainage to flow through the downspout extension as designed. Without support under the downspout extension it will tend to sag, disrupting the pitch which in turn impedes proper drainage flow; and in some cases causes backflow.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A downspout extension support device, comprising:
a substantially U-shaped upper portion and a ground stake lower portion;
said upper portion comprising a first upstanding member and a second upstanding member, each having a lower end and an upper distal end;
said lower end of each upstanding member connected to a central region;
said ground stake lower portion comprising an upper end, a lower end, and an elongated length;
said elongated length having a graduated measurement indicia extending therealong;
said upper distal end of said first upstanding member and said second upstanding member further comprising an inwardly directed tab.

2) The downspout extension support device of claim 1, wherein said upper portion and said ground stake lower portion comprise a unitary, molded part.

3) The downspout extension support device of claim 1, wherein said ground stake lower end further comprises a tapering cross section between said upper end and said lower end thereof.

4) The downspout extension support device of claim 1, wherein said first upstanding member and said second upstanding member mirror one another about said central region.

5) The downspout extension support device of claim 1, wherein said first upstanding member and said second upstanding member are substantially parallel and transition to a substantially perpendicular portion along said lower end thereof.

6) The downspout extension support device of claim 1, wherein:
said upper portion and said lower portion further comprise a front and rear surface;
said upper portion and said lower portion further comprise a raised vein extending outward from said front and rear surface thereof.

7) The downspout extension support device of claim 1, wherein said graduated measurement indicia further comprise consecutive numbers equally spaced from one another along said ground stake lower portion and extending from said upper end to said lower end thereof.
